(19) United States
(12) Patent Application Publication
(10) Pub. No.: US 2012/0038827 A1
(43) Pub. Date: Feb. 16, 2012

(54) SYSTEM AND METHODS FOR DUAL VIEW VIEWING WITH TARGETED SOUND PROJECTION

(76) Inventor: Charles Davis, Trabuco Canyon, CA (US)

(21) Appl. No.: 12/854,782

(22) Filed: Aug. 11, 2010

(51) Int. Cl. H04N 9/74; H04N 5/66

(52) U.S. Cl. 348/588; 348/E09.055; 348/E05.133

(57) ABSTRACT

Systems and methods that facilitate dual view video display with dual beam sound projection. Video signal from independent input sources are simultaneously and separately viewable on a display by viewer wearing shutter glasses. The sound projector preferably comprises an array of speakers configurable to project beams of independent audio signals to separate targeted locations.

### FIELD OF THE INVENTION

The subject matter described herein relates generally to televisions and sound projection systems and more particularly to systems and methods that facilitate simultaneous full screen viewing of video signals from two independent video input sources with independent audio from a single television.

### BACKGROUND INFORMATION

Agreement between family or group members over what to watch or play on a television is not always possible. For example, parents may want to watch news or sports but the kids may want to watch cartoons or play a video game, a husband may want to watch football but his wife may want to watch a movie, or one viewer may want to play a game on one game console while a second viewer may want to play a game on a different game console. In order to simultaneously view video signals from two independent video input sources, e.g., video from a blue ray player and video from a game console, conventional televisions would need to be placed in a picture-in-picture (PIP) or side-by-side viewing format mode. In addition to not being able to view the video signal on the full screen of the television, the other video signal can be distracting to the viewer.

Accordingly, it would be desirable to enable with a single television simultaneous full screen viewing of video signals from two independent video input sources with independent audio corresponding to the two video signals.

### SUMMARY

The embodiments provided herein are directed to systems and methods that facilitate dual view video display which enables simultaneous full screen viewing of video signals from two independent video input sources with corresponding independent audio from a single television. The video signals from two independent audio-video input sources are combined and displayed on the video display screen of the television in a manner that enables the images of each video signal to be separately viewable by viewers wearing shutter glasses. Instead of the shutter glasses switching between left and right views in a 3D viewing system, the shutters on the glasses can switch simultaneously allowing each viewer to only see their desired image.

In one embodiment, the television preferably comprises audio and video input connections and audio-video outputs such as an integral sound projector and a video display screen coupled to a control system. The control system includes a micro processor and non-volatile memory upon which system control software is stored, a video scaler on screen display (OSD) controller/audio mux (“OSD controller”) coupled to the micro processor and the video signal input connections, an image display engine/timing controller coupled to the OSD controller and the display screen. The control system is configured to combine the input video signals from two separate input audio-video sources and display the combined signals on the video display screen of the television. The video signals are preferably filtered and combined in a checkerboard (quincunx) format with one source occupying the even pixels and the second source occupying the odd pixels of a single frame. Depending on the display technology it may be more desirable to have the two sources combined in a side-by-side, frame sequential or other format. The two sources can be combined in whatever format the display technology requires to display 3D viewing with one source occupying the left eye pixels and the other source occupying the right eye pixels.

The control system further comprises an audio processor such as a digital sound processor coupled to the micro processor and the sound projector. The audio input connections preferably include conventional audio input connections. The sound projector preferably comprises an array of speakers configurable to inject sound beams into a room that the television is located as either one or more targeted beams of sound toward targeted locations or beams of sound that reflect off the walls and ceiling to create surround sound. In one embodiment, the control system is configured to cause the sound projector to inject the audio signals from two separate audio-video input devices as separate beams of sound to two different target locations allowing each viewer to only hear their desired audio.

In operation, the video signals from the first and second audio-video input sources are combined. The combined video signals are displayed on the display screen and the shutters on the glasses worn by each viewer switch simultaneously allowing each viewer to only see their desired image. Each audio signal from the first and second audio-video input device is separately injected from the sound projector to two different targeted locations allowing each viewer to only hear their desired audio.

In other embodiments, the user using the menu system and graphical user interface displayable on the screen of the television and generated by the control system software, can select between different viewing modes of operation including mono view, PIP, side-by-side, dual view and the like, and different audio modes of operation including stereo, surround, mono targeted, dual targeted and the like, choose audio-video input sources, configure the sound projection system for the user viewing room and component configuration, and automatically calibrate or customize the sound beam parameters of the sound projection system using a microphone couplable to the control system or manually adjust the sound beam parameters by navigating the graphical user interfaced based menu system. Once the room, component and sound beam parameters are entered, the control system will draw graphical representations of the sound beams and display the graphical representations of the sound beams within a graphical representation of the user's viewing room on the TV screen. The user can further use the graphical user interfaced menu system to move the sound beams around the viewing room while being presented with a graphical representation of the same.

Other systems, methods, features and advantages of the invention will be or will become apparent to one with skill in the art upon examination of the following figures and detailed description.

### BRIEF DESCRIPTION OF THE FIGURES

The details of the embodiments provided herein, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic of a dual view video display and integral sound projection system.

FIG. 2 depicts a schematic of a dual view video display system.

FIG. 3 depicts a schematic of a television with an integral sound projector and control system.

FIG. 4A depicts a graphical user interfaced based menu displayed on the display screen of the television with the sound projector configuration menu displayed.

FIG. 4B depicts a graphical user interfaced based menu displayed on the screen of the television with the sound projector configuration menu and custom soft key drop down menu displayed.

FIG. 4C depicts a graphical user interfaced based menu displayed on the screen of the television with the video mode drop down menu displayed.

FIG. 4D depicts a graphical user interfaced based menu displayed on the screen of the television with the audio mode drop down menu displayed.

FIG. 5A depicts a graphical user interfaced based menu displayed on the screen of the television with the sound projector surround mode custom setup menu displayed with a graphical tracing of the paths of the sound beams displayed.

FIG. 5B depicts a graphical user interfaced based menu displayed on the screen of the television with the sound projector surround mode custom setup menu displayed with a graphical tracing of the paths of the sound beams displayed as modified by the user.

FIG. 6 depicts a graphical user interfaced based menu displayed on the screen of the television with the sound projector dual-target mode custom setup menu displayed.

### DETAILED DESCRIPTION

The systems and methods described herein are directed to a television with an integral sound projection system and the control and operation of the television and integral sound projection system that enables dual view video display viewing. In dual view video display viewing, video signals from two independent video input sources with corresponding independent audio signals are viewable simultaneously on the full screen of a single television. The video signals from two independent audo-video input sources are combined and displayed on the video display screen of the television in a manner that enables images of each of the video signals to be separately viewable by viewers wearing shutter glasses. Instead of the shutter glasses switching between left and right views in a 3D viewing system, the shutters on the glasses can switch simultaneously allowing each viewer to only see their desired image.

In one embodiment the television includes an integral sound projector comprising an array of speakers. The array of speakers is configurable to inject beams of sound into a room in which the television is located, which can be targeted to one or more locations or reflect off the walls and ceiling of the room to create surround sound. A detailed description of televisions with integral sound projection systems are described in application Ser. Nos. 12/487,861 and 61/094,037, which are incorporated herein by reference.

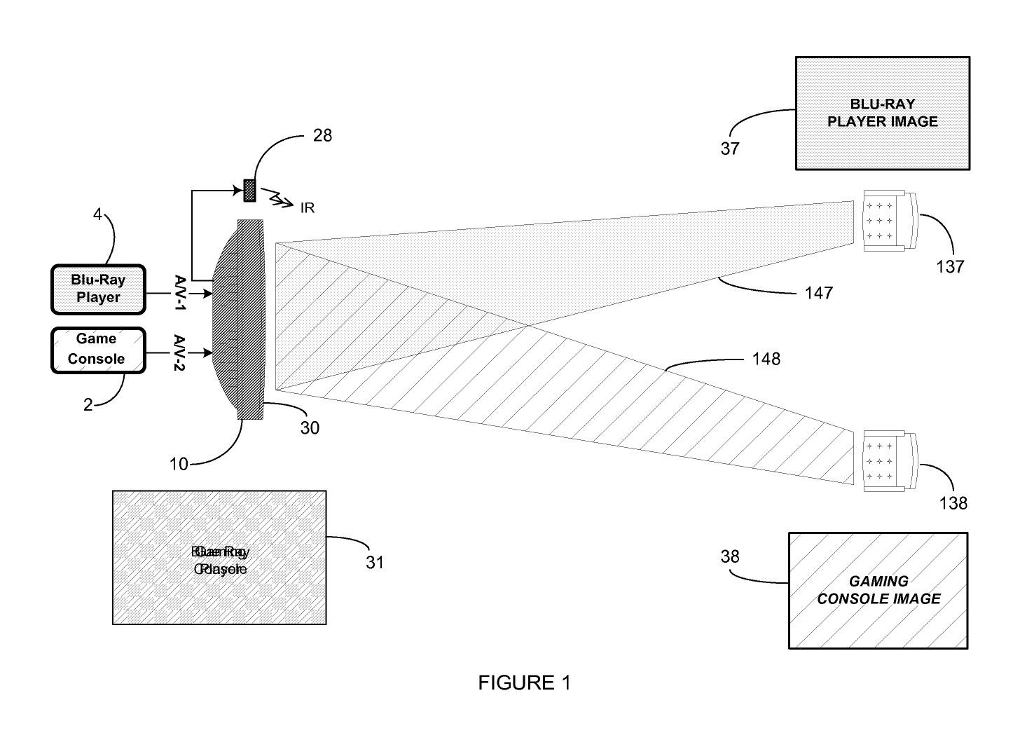

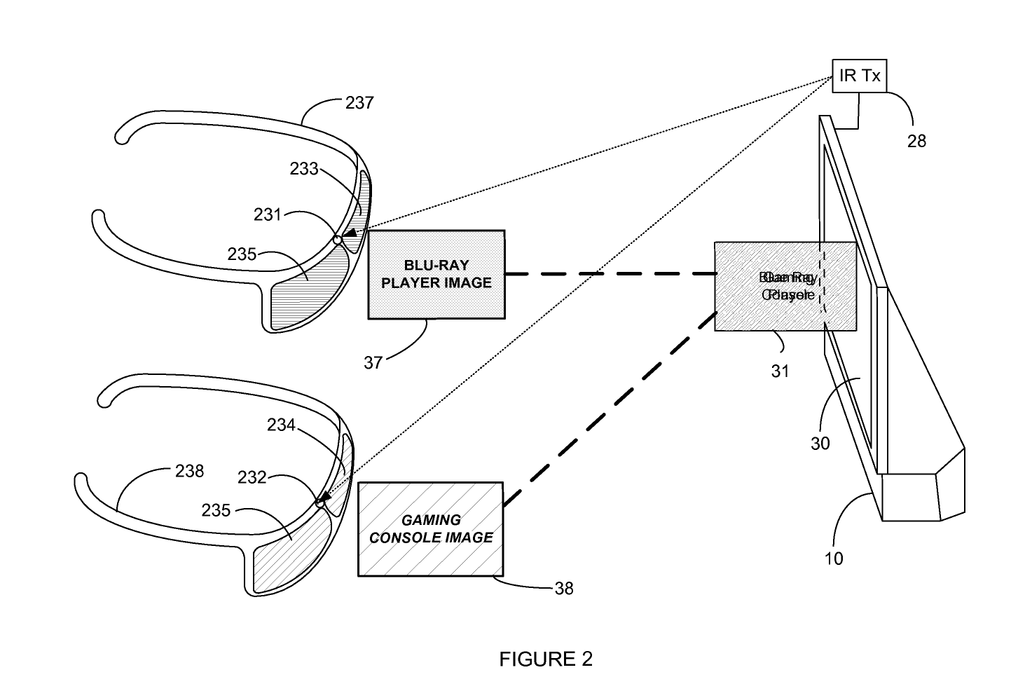

Turning in detail to the figures, FIGS. 1 and 2 depict a dual view video display and integral sound projection system that includes a television 10 with an integral sound projection system and viewer shutter glasses 237 and 238. As depicted, a first audio-video input source depicted as a game console 2 and a second audio-video input source depicted as a blue ray player 4 are coupled to audio-video input ports A/V-1 and A/V-2 of the television 10. The television 10 is configured to combine the video signals of the first and second input sources 2 and 4 and display the combined signal on the video display screen 30 of the television 10. As depicted as combined image 31, the video signals are filtered and combined.

The image 31 of the combined video signals from the two independent audio-video input sources 2 and 4 displayed on the video display screen 30 of the television 10 is viewable as separate images, e.g., a blue ray player image 37 and a gaming console image 38, by viewers wearing shutter glasses 237 and 238 and positioned at sound target positions 137 and 138. Instead of the left and right shutters 233, 234 and 235, 236 of the shutter glasses 237 and 238 switching between left and right views in a 3D viewing system, the left and right shutters 233, 234 and 235, 236 on the glasses 237 and 238 switch simultaneously allowing each viewer to only see their desired image 37 or 38.

An IR blaster module 28 is preferably used to transmit IR timing signals to IR receivers 231 and 232 on the shutter glasses 237 and 238 to synchronize the shutters of the glasses 237 and 238 with the refresh of the video display screen 30 while the video display screen 30 alternately displays separate images 37 and 38 for each user corresponding to video signals received from the first and second audio-video input sources 2 and 4. Alternatively, the synchronizing or timing signal can be transmitted using radio frequency, DLP-Link or Bluetooth transmitters. The shutters 233, 235 and 234, 236 glasses 237 and 238 simultaneous darken and lighten over both eyes of the viewer in synchronization with the refresh rate of the video display screen 30.

In dual view mode, the television 10 and integral sound projector are configured to inject separate targeted beams of sound 147 and 148 comprising the separate audio signals corresponding to the video signals received from the first and second audio-video input sources 2 and 4. As depicted, the sound beams 147 and 148 are injected into a room toward to two different target locations 137 and 138 allowing each viewer to only hear their desired audio.

In operation, the audio and video signals from the first and second audio-video input sources 2 and 4 are combined. The combined video signals are displayed on the display screen 30 of the television 10 and the shutters 233, 235 and 234, 236 on the glasses 237 and 238 worn by each viewer switch simultaneously allowing each viewer to only see their desired image 37 or 38. Each audio signal from the first and second audio-video input source 2 and 4 is injected into the viewing space from the sound projector as separate sound beams 147 and 148 toward two different targeted locations allowing each viewer to only hear their desired audio.

The dual view video display and integral sound projection system advantageously enables full screen viewing of video from two independent audio-video sources simultaneously with independent audio from a single television. The images in the videos signals from each of the independent video sources are advantageously displayed full screen rather than in a PIP (side-by-side) type of format. For example, the system enables parents to watch news/sports while their kids watch cartoons or play video games; a husband to watch football while his wife watches a movie; viewer one to play a video on one type of gaming console while viewer two plays a video game on another type of gaming consol.

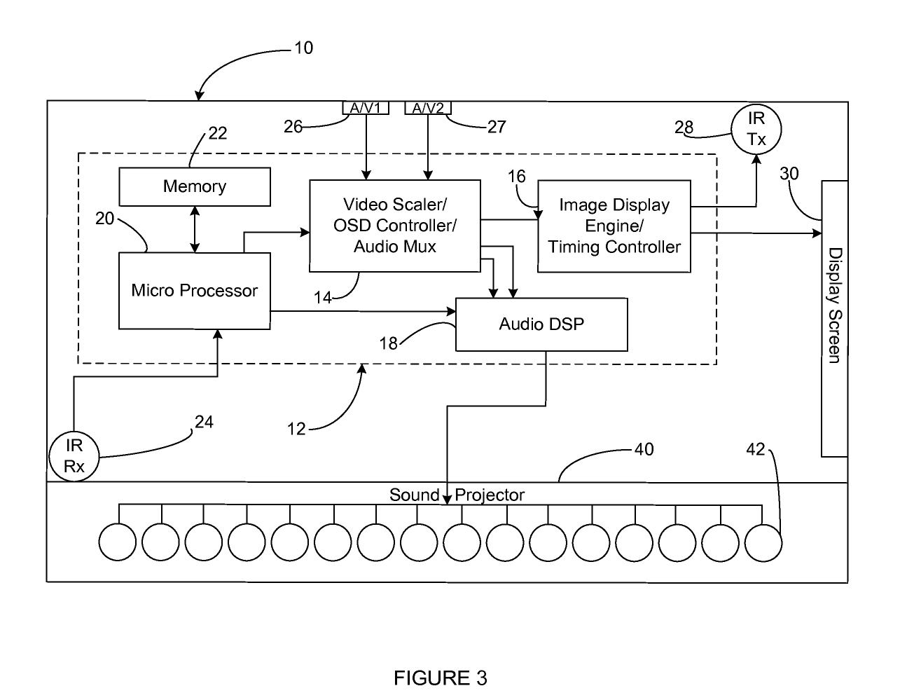

Referring to FIG. 3, a schematic of an embodiment of a television 10 with an integral sound projector 40 comprising an array of speakers 42 is depicted. As shown in FIG. 1, the television 10 preferably comprises a video display screen 30, an IR signal receiver 24, an IR transmitter 28, audio-video input ports 26 and 27, and the sound projector 40 coupled to a control system 12. The control system 12 preferably includes a micro processor 20 and non-volatile memory 22 upon which system software is stored, a video scaler/on screen display (OSD) controller/audio mux 14 coupled to the micro processor 20 and an image display engine/timing controller 16 coupled to the video scaler/OSD controller/audio mux 14 and the display screen 30. The control system 12 further comprises an audio processor 18, such as an audio digital sound processor (DSP) or the like, coupled to the micro processor 20 and the sound projector 40.

The system software preferably comprises a set of instructions that are executable on the micro processor 20 and/or the audio processor 18 to enable the setup, operation and control of the television 10 including the setup, operation and control of the sound projector 40. The system software provides a menu-based control system that is navigatable by the user through a graphical user interface displayed or presented to the user on the television display 30. While on the television layer of the television remote control unit, the user can navigate the graphical user interface to setup, operate and control the television 10, its integral sound projector, and external A-V input devices, such as, e.g., a DVD, a VCR, a cable box, and the like, coupled to the television 10. A detailed discussion of a graphical user interface-based menu control system and its operation is provided in U.S. Published Patent Application No. US 2002-0171624 A1, which is incorporated herein by reference.

In operation while in dual view mode, the microprocessor 20 instructs the video scaler/OSD controller/audio mux 14 to combine the video signals received from audio-video input ports 26 and 27 and display the combined video signal on the display screen 30. The microprocessor 20 also instructs the audio DSP 18 to have the sound projector 40 to project the audio signals from the audio-video input ports 26 and 27 to separate locations within the room the television 10 is located. Although shown as first and second audio-video input ports 26 and 27, one skilled in the art would readily recognize that the television 10 could have a plurality of audio-video input ports, a plurality of video input ports, and a plurality of audio input ports.

In operating the television 10, the user using the menu system and graphical user interface displayable on the screen 30 of the television 10 and generated by the system software executed on the micro processor 20, can select between different modes of video operation including mono view, PIP, side-by-side and dual view and can select between different modes of audio operation including stereo, surround sound, targeted single or mono sound beam, targeted dual sound beams and the like. Using the graphical user interface based menu system, the user can also configure the sound projection system in accordance with the user's viewing room parameters such as room dimensions, television location, distance of couch or main seating area from the television. Once the sound projection system is configured in accordance with the user's viewing room parameters, the user can select to automatically calibrate the sound beam levels using a microphone couplable to the control system. Alternatively, the user can navigate the graphical user interface based menu system to adjust the sound beam parameters such as sound beam levels and angels. Once the viewing room and sound beam parameters are entered or received by the control system, the control system will draw graphical representations of the sound beams and display the graphical representations of the sound beams within a graphical representation of the user's viewing room on the television display screen 30. The user can further use the graphical user interfaced menu system to adjust the angles of the sound beams and move the sound beams around the viewing room while being presented with a graphical representation of the same.

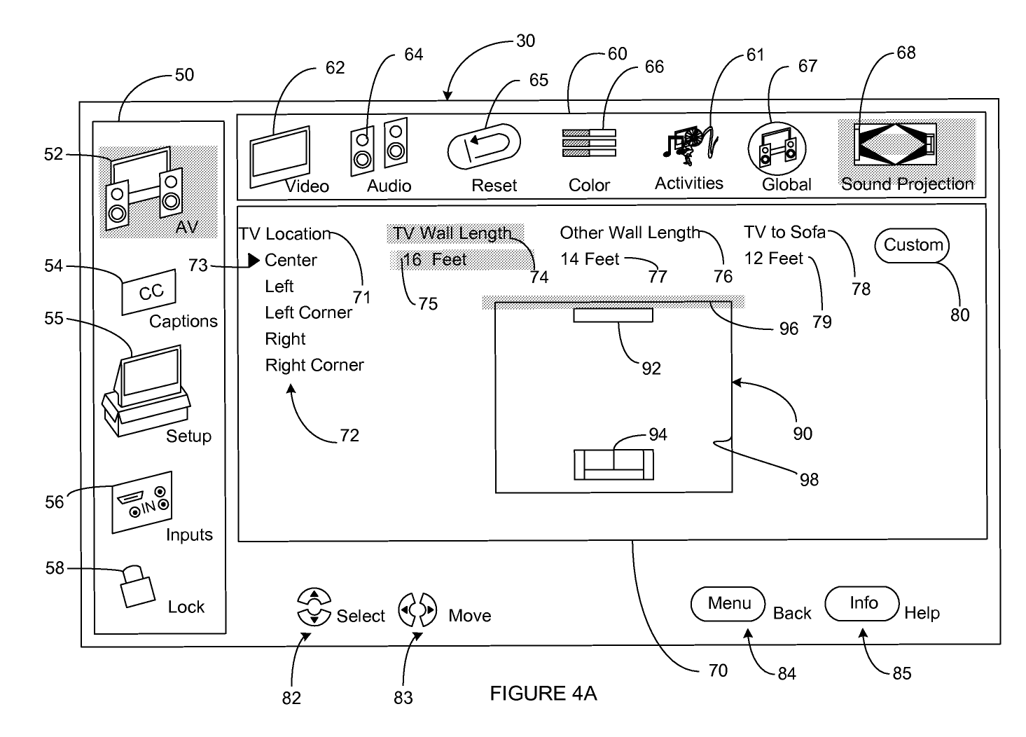

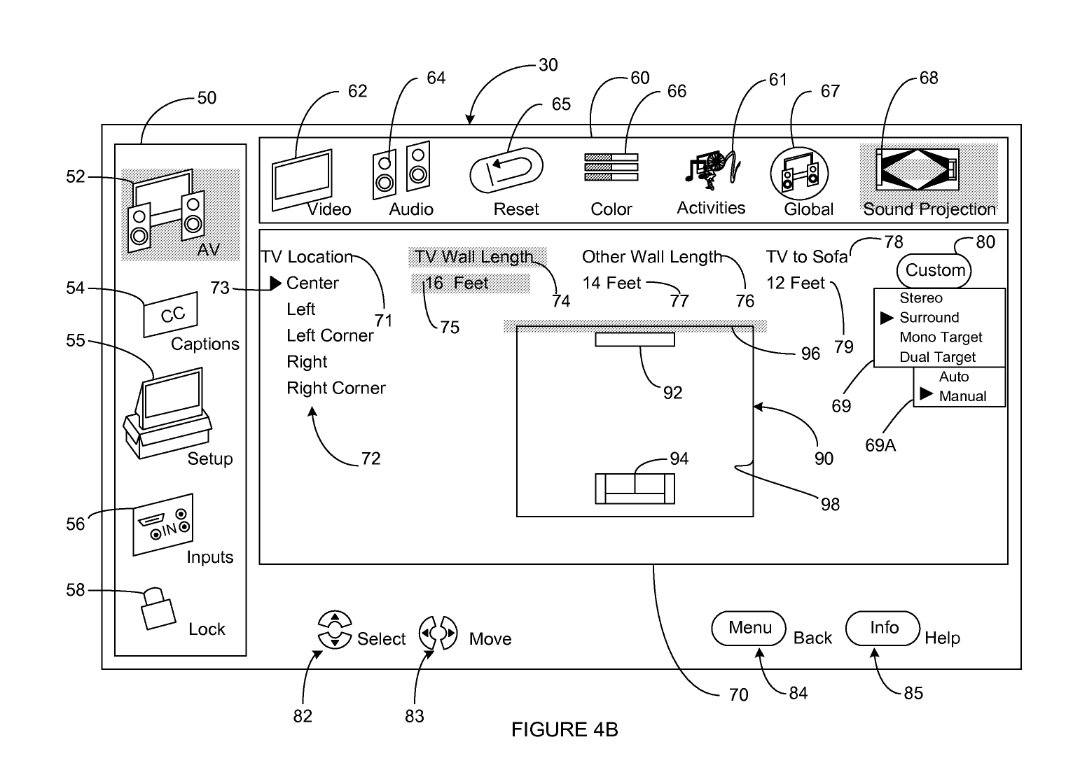

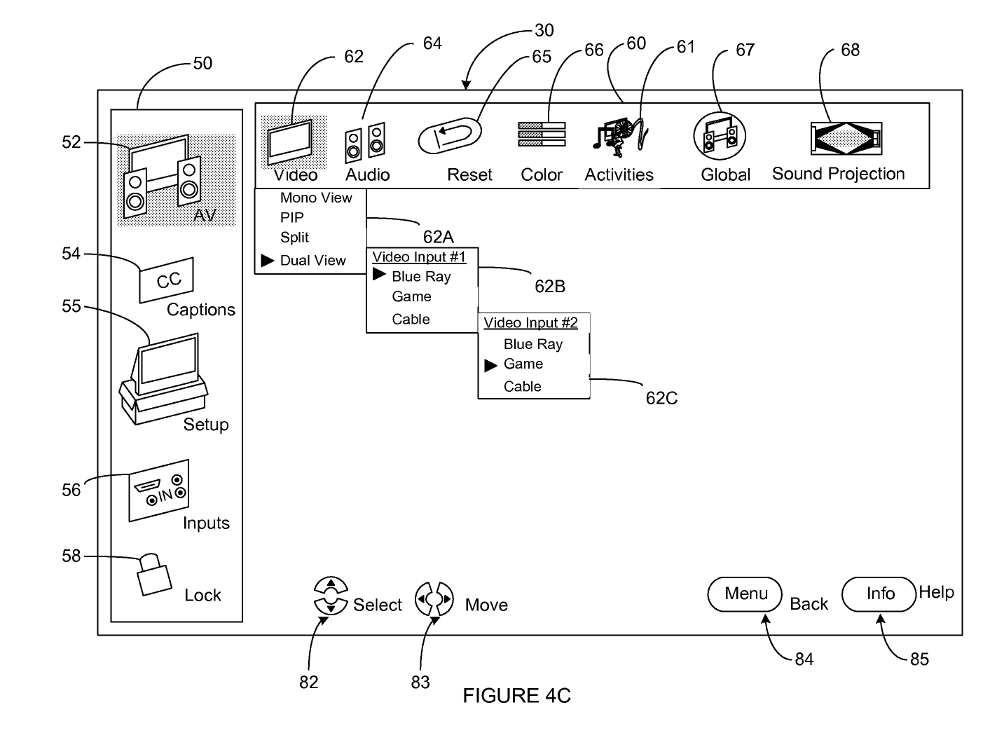

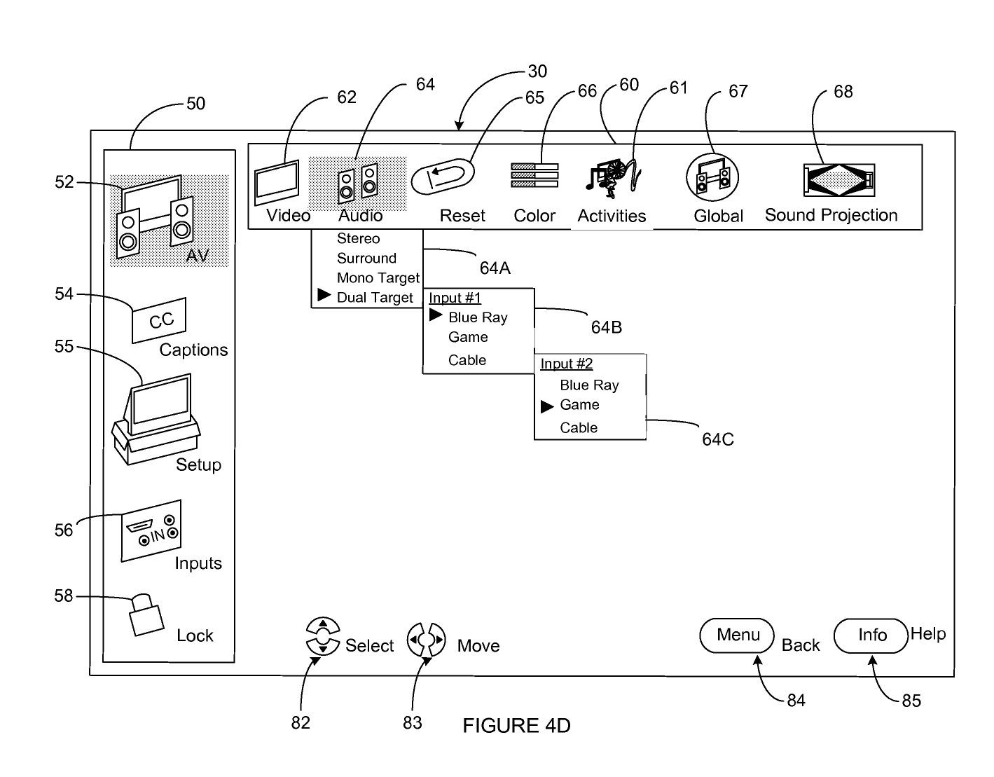

Turning to FIGS. 4A and 4B, configuring the sound projection system using the television's graphical user interfaced-based multi-layer menu system will be discussed. Upon pressing the menu key on a control panel on the television 10 or on a remote control unit, the user is presented with a system configuration menu 50 preferably along the left side of the screen 30. The configuration menu 50 preferably comprises selectable graphical icons representing menu options corresponding to functions and/or devices the user can configure such as, e.g., AV devices 50, captions 54, “out of the box” system setup 55, input devices 56 and security systems 58. The user is also presented with a navigation key or guide indicating which keys to press on the remote control to accomplish navigation functions such as “select” 82, “move” 83, “back” 84 and “help” 85. Highlighting, as depicted using gray shading about the icon for the AV device 52 menu option, is used to indicate location within a menu and selected menu item.

Upon selecting the AV device 52 menu option in the system configuration menu 50, a device configuration menu 60 is preferably displayed along the top of the screen 30. The device configuration menu 60 preferably includes selectable graphical icons representing menu option corresponding to functions or devices such as, e.g., video 62, audio 64, reset 65, picture color 66, internet 67, sound projection 68 and the like.

Upon selecting the sound projection 68 menu option in the device configuration menu 60, a sound projection system configuration menu 70 is displayed in the central portion of the screen 30. The sound projection system configuration menu 70 includes an image 90 comprising a graphical representation of the user's television viewing room, and list of the viewing room parameters such as, e.g., television location 71, television wall length 74, other wall length 76 and distance from the television to a sofa or primary seating area 78, which are needed by the system software to configure the projection sound system to inject sound beams into the viewing room and reflect the sound beams off the walls and ceiling to create surround sound. As depicted in the image of the viewing room 90, the television wall length parameter 74 refers to the length of a wall in the user's television viewing room corresponding to the wall 96 that the television 92 is depicted as positioned on, the other wall length parameter 76 refers to the length of a wall in the user's television viewing room corresponding to the wall 98 that the television 92 is not depicted as positioned on, and the television to sofa parameter 78 refers to the distance between a television and a sofa or primary viewing area in the user's television viewing room corresponding to the television 92 and sofa 94 as depicted in the image of the viewing room 90.

As the selector indicator arrow 73 is moved from one television location option 72 to another, the television 92 is preferably depicted at the selected position 72 along wall 96 in the image of the viewing room 90. The user can navigate between the viewing room parameters and enter parameter values 75, 77 and 79.

With the room parameters entered by the user and received by the control system 12, the system software calculates the beam angles for five surround sound beams such as, e.g., front right, front left, center, rear right and rear left beams, to emanate from the speaker array 42 of the sound projector 40 and orients or configures the individual speakers of the speaker array 42 accordingly.

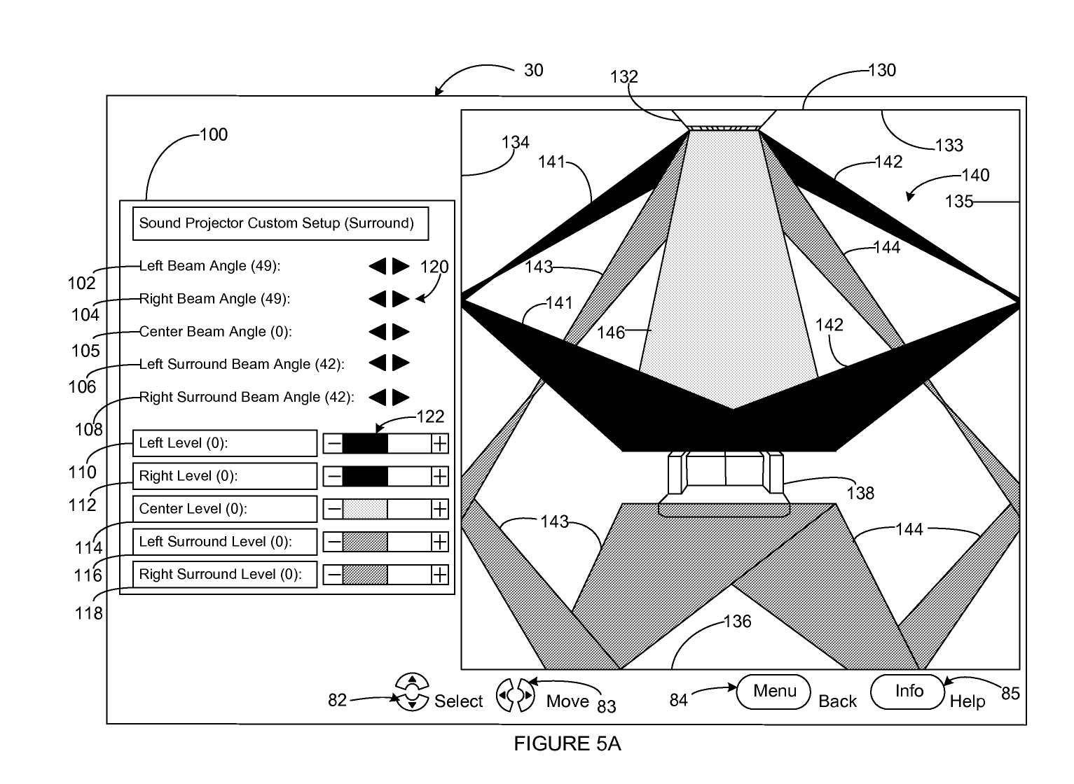

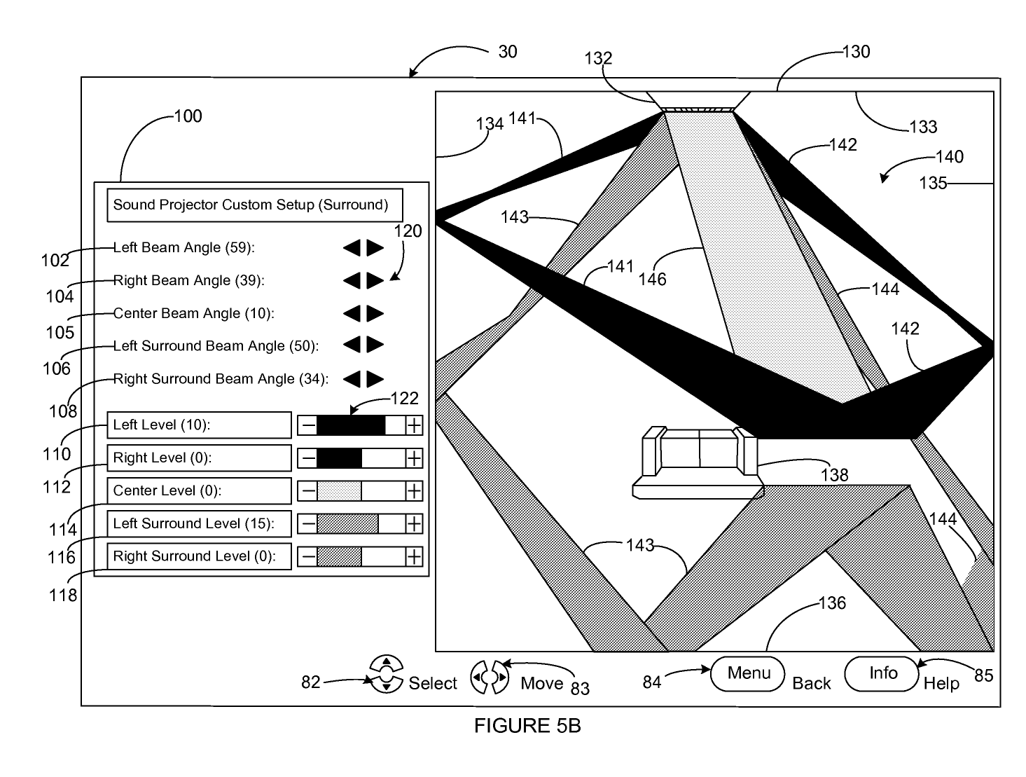

By selecting the soft key 80 labeled “custom” in the sound projection configuration menu 70, the user is presented, as depicted in FIG. 5A with graphical traces 140 of the paths the sound beams will follow or follow in the television viewing room. The traces 140 corresponding to, e.g., a front left sound beam 141, a front right sound beam 142, a center sound beam 146, a rear left sound beam 143, and a rear right sound beam 144 of surround sound, are displayed on the screen 30 in an graphical image 130 representing the television viewing room with a front or television wall 133, a back wall 136, side walls 134 and 135, a television 132 positioned along the television wall 133 and a couch 138 positioned within the image 130 of the television viewing room in spaced relation with the television 132.

As one skilled in the art would readily understand, audio sound beams reflect off the walls of the television viewing room following the general law of reflection in physics of “angle of incidence equals angle of reflection”. The function within the system software that draws the traces 140 includes a loop that draws each segment of a sound beam as a polygon. The corner points of the polygon are calculated through a “point bounce” function that finds the points where a straight line will bounce when shooting the line from a particular point in at a particular angle in a room of particular dimensions, and then uses the law of reflection to return the bounce angles on the room walls. Each side of the beam is calculated separately, but when drawn on the screen the two side lines of a beam represents four end points of a beam polygon.

Representative software code corresponding to the “point bounce” function preferably includes:

while (drawing beam segments)
{

If (beam segment starts above sofa)
{

If (beam segment hits sofa)
{

Draw polygon of beam to stop at sofa level (from top);

}
else
{

Draw polygon of beam to hit next bounce points on wall.
If (beam hits corner of room)
{

Terminate further beam drawing, illegal reflection;

}

}

}
else //beam segment starts below sofa
{

If (beam segment hits sofa)
{

Draw polygon of beam to stop at sofa level (from bottom);

}
else
{

Draw polygon of beam to hit next bounce points on wall;

}

}
Beginning of next beam segment is set equal to end of previous beam
segment;

}
The “sofa level” is the horizontal line of where the sofa is.

In order to efficiently draw the polygons and display the polygons on the screen 30 as shown in FIG. 5A and move them about the room as depicted in FIG. 5B in response to a user depressing the right or left cursor keys 83 on the remote control, the registers of the sound processor 18 are synchronized with the electronic key of the remote control. Process for controlling the synchronization of the sound processor registers with the key of the remote control includes translating the electronic key of the remote control into a two's complement number used directly in setting up and controlling the registers for each of the discrete channels in the sound processor. The keys are interpreted in real time such that when a user presses a left or right cursor key on the remote control, the bits from the electronic key of the remote control are converted into two's complement number which is then generated and sent to the sound processor 18 to synchronize the discrete channel.

The method for efficiently rendering polygons is based on the electronic key repeats of the remote control. Efficiently rendering multiple polygons on the screen 30 to simulate sound beam reflections requires the methods of flipping the pixel images to transparency and back to a specific color and location such that the polygon images appears to be a new pixel location with each iteration. Converting the image to transparency provides a clean base for the next iteration. The method for efficiently rendering polygons is effectively an internal iterator that is controlled by electronic key rate of the remote control. The faster the rate the faster the images are converted to transparency to provide a clean base for the next iteration and rendering.

Turning back to FIGS. 4A and 4B, the user can select the “custom” soft key 80 in the sound projection configuration menu 70, to view and adjust the approximate angles of the sound beams as represented by the graphical polygon traces 140. As depicted in FIGS. 5A and 5B, a sound projector setup menu 100 is displayed on the screen 30 along with the image 130 of the television viewing room containing graphical polygon traces 140. The sound projector setup menu 100 includes selectable menu options with current value settings indicated that correspond to the left beam angle 102, the right beam angle 104, the center beam angle 105, the left surround beam angle 106, and the right surround beam angle 108. The value of each beam angle can be adjusted by pressing the right or left cursor keys 83 on the remote control as indicated by menu key or guide 120. As the cursor keys 83 are pressed, the indicated angle value of the selected menu option will change as well as the angle and, thus, position of the corresponding polygon trace, the results of which are depicted in FIG. 5B, enabling the user to visually move the sound beams around the room to approximate locations.

In addition, the sound projector setup menu 100 includes selectable menu options with current value settings indicated that correspond to the sound level of left beam 110, the right beam 112, the center beam 114, the left surround beam 116, and the right surround beam 118. The level of each beam can also be adjusted by using the slider 122.

As graphically depicted in FIGS. 1, 2, 4A, 4B, 4C, 4D, 5A, 5B, 6, 7, and 8, the television 10 with integral sound projector 40 can operate in a variety of video modes including mono view, PIP, side-by-side, and dual view, and a variety of audio modes including surround, stereo and single or multiple targeted beams. As depicted in FIG. 4B, when the “custom” soft key 80 is selected, an audio mode configuration drop down menu 69 or the like is displayed prompting the user to select an audio mode of operation to configure. Once an audio mode is selected, an auto/manual drop down menu 69A or the like is displayed prompting the user to select automatic or manual configuration of the selected audio mode of operation. If the “automatic” option is selected, the sound beam levels will automatically be calibrated based on the current viewing room and beam parameter settings. If the “manual” option is selected, a sound projection custom setup menu and television viewing room image will be displayed on the screen 30 prompting the user to adjust the beam angle and/or beam level as depicted in and discussed above with regard to FIGS. 5A and 5B.

As depicted in FIG. 4C, the user can select a video mode of operation by selecting the Video icon 62 in the AV device configuration menu 60. When Video icon 62 is selected, a video mode selection drop down menu 62A or the like is displayed prompting the user to select a desired video mode of operation. If the user selects PIP, Split or Dual View, a video input selection drop down menu 62B or the like is displayed prompting the user to select a desired video source as video input 1. A second video input selection drop down menu 62C or the like is then displayed prompting the user to select a desired video source as video input 2. Preferably, the control system automatically assigns the audio sources corresponding to video inputs 1 and 2 to audio inputs 1 and 2 as described below with regard to FIG. 4D.

As depicted in FIG. 4D, the user can select an audio mode of operation by selecting the Audio icon 64 in AV device configuration menu 60. When Audio icon 64 is selected, an audio mode selection drop down menu 64A or the like is displayed prompting the user to select a desired audio mode of operation. If the user selects Dual Target, an audio input selection drop down menu 64B or the like is displayed prompting the user to select a desired audio source as audio input 1. A second audio input selection drop down menu 64C or the like is then displayed prompting the user to select a desired audio source as audio input 2. Preferably, the control system automatically assigns the video sources corresponding to audio inputs 1 and 2 to video inputs 1 and 2 as described above with regard to FIG. 4C.

Adjustment of the audio mode settings can be made by returning the sound projection configuration menu 70 and selecting the custom soft key 80.

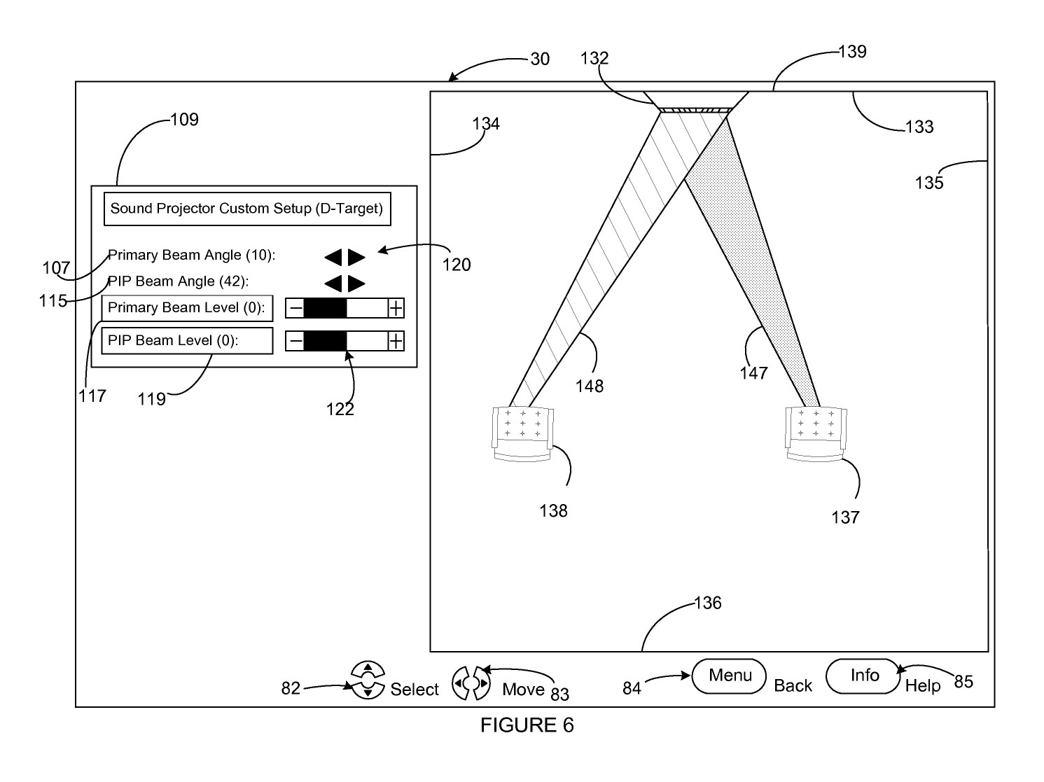

If the custom soft key 80 is selected and manual configuration of the dual target beam mode is selected from the audio mode configuration menus 69 and 69A, as depicted in FIG. 6, a sound projector custom setup menu 109 and a television viewing room image 139 graphically depicting two or dual sound beams 147 and 148 emanating from the sound projector of the television 132 are displayed on the screen 30. As depicted, the sound projector custom setup menu 109 preferably includes menu options corresponding to beam angles 107 and 115 of the two beams 147 and 148. As indicated, the beam angle value can be adjusted to move the two sound beams around the room to approximate targeted locations within the room. If the PIP or Split screen mode of operation is selected from the video menu, the dual beam mode can be used to allow two viewers to watch picture-in-picture or split screen video with the one beam or the primary sound beam 145A being assigned to the main picture or one of the pictures in the split screen and the other sound beam 145B being assigned to the PIP or other picture in the split screen. If the Dual View mode of operation is selected from the video menu, the dual beam mode can be used to allow two viewers to simultaneous watch full screen video from separate input source with the one sound beam 147 being assigned to the video from one input source and the other sound beam 148 being assigned to the video from the other input source.

In addition, the sound projector custom setup menu 109 preferably includes menu options corresponding to the sound levels 117 and 119 of the two beams, which can be adjusted with the slide 122.

As one skilled in the art would readily recognize, this process can be used for the automatic setup of audio levels and delays in surround systems with televisions that serve the AVR function and include an integral surround sound decoder and either a sound projector, a power amplifier or wireless transmitters for discrete external speakers.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A television system comprising
a television comprising
audio and video input connections,
a video display screen, and
a control system coupled to the audio and video input connections and video display screen, wherein the control system is configured to combine input video signals from first and second input audio-video sources coupled to the video input connection and alternately display separate images from the combined signals on the video display screen, and
first and second shutter glasses operably coupled to the control system, wherein the shutters on each of the first and second glasses are configured to switch simultaneously enabling simultaneous full screen viewing of the input video signal from the first input audio-video source through the first shutter glasses and the input video signal from the second input audio-video source through the second shutter glasses.

2. The television system of claim 1 wherein the television further comprises an integral sound projector coupled to the control system.

3. The television system of claim 2 wherein the control system and integral sound projector are configured to project a first sound beam of a first input audio signal from the first input audio-video source in a first targeted direction and a second sound beam of a second input audio signal from the second input audio-video source in a second targeted direction.

4. The television system of claim 3 wherein the control system comprises a micro processor, non-volatile memory, system control software stored on the non-volatile memory and executable on the micro processor, an on screen display controller coupled to the micro processor and the video signal input connections, an image display engine coupled to the on screen display controller and the display screen.

5. The television system of claim 4 wherein the control system further comprises an audio processor coupled to the micro processor and the sound projector.

6. The television system of claim 5 wherein the audio processor is a digital sound processor.

7. The television system of claim 6 wherein the sound projector comprises an array of speakers configurable to inject sound beams into a room that the television is located.

8. The television system of claim 7 wherein the television further comprises a menu based user control system displayable on the screen of the television and generated by the control system software.

9. The television system of claim 8 wherein the television further comprises a menu based user control system includes a graphical user interface.

10. The television system of claim 9 wherein the television further comprises a synchronizing signal transmitter configured to transmit timing signals receivable by the first and second shutter glasses to synchronize the shutters of the first and second shutter glasses with a refresh rate of the video display screen as the video display screen alternately displays separate images corresponding to each of the combined signals received from the first and second audio-video input sources.

11. A method for simultaneous full screen viewing on the display screen of a television of separate video signals from first and second audio-video input sources coupled to the television, comprising the steps of
combining first and second video signals from first and second audio-video input sources coupled to the television,
displaying on the display screen of the television the combined first and seconde video signals,
simultaneously switching shutters on a first pair of shutter glasses and shutters on a second pair of shutter glasses enabling simultaneous full screen viewing of the input video signal from the first input audio-video source through the first pair of shutter glasses and the input video signal from the second input audio-video source through the second pair of shutter glasses.

12. The method of claim 11 further comprising the step of
injecting into a viewing space from a sound projector integral with the television first and second sound beams of first and second input audio signals from the first and second input audio-video sources toward first and second targeted locations.

13. The method of claim 12 further comprising the steps of
transmitting a synchronizing signal from the television, and
receiving the synchronizing signal and synchronizing the shutters of the first and second shutter glasses with a refresh rate of the video display screen as the video display screen alternately displays separate images corresponding to each of the combined signals received from the first and second audio-video input sources.

14. The method of claim 13 further comprising the step of adjusting the direction of the first and second targeted sound beams and displaying a graphical representation of the first and second targeted sound beams.
